(19) United States
(12) Patent Application Publication
(10) Pub. No.: US 2004/0023828 A1
(43) Pub. Date: Feb. 5, 2004

(54) Dryer sheet enhancer

(76) Inventor: James P. Grippo, Murrysville, PA (US)

Correspondence Address: JAMES RAY & ASSOCIATES, 2640 PITCAIRN ROAD, MONROEVILLE, PA, 15146, US

(21) Appl. No.: 10/379,307

(22) Filed: Mar. 4, 2003

Related U.S. Application Data
(60) Provisional application No. 60/400,251, filed on Jul. 31, 2002.

(51) Int. Cl. C11D 3/00; D06L 1/00

(52) U.S. Cl. 510/327; 510/515

(57) ABSTRACT

An approach to greatly improving the effectiveness of a dryer sheet during an automated dryer cycle will significantly enhance the usefulness of all types of dryer sheets. Through the use of this invention a more uniform distribution of softening agents, and a reduction of static electricity to articles during the automated dryer cycle will occur.

### FIELD OF THE INVENTION

The present invention generally relates to dryer added fabric care and methods for using the same during the drying cycle of either an individual consumer or a commercially operated laundry process. More particularly, the invention relates to the reduction of static electricity, and an improvement in the softening of articles during the automated drying process.

### BACKGROUND OF THE INVENTION

A laundry dryer sheet provides multiple purposes. As its main purpose, to soften the articles of the drying load, and second to reduce the presence of static electricity, commonly known as “static cling”. During a typical dryer cycle the tumbling action of the dryer and the low humidity present at the end of the drying cycle build electronic charges as different fabrics, such as; synthetics, rub together and exchange electrons. The dryer sheet is treated with softening agents, which when released provides a lubrication effect that gives the articles similar surface make-up. This lubrication effect not only softens the articles, but aids in reducing the presence of static electricity by limiting the exchange of electrons among the articles.

However, due to its physical characteristics, the dryer sheet as a medium is limited to its ability to evenly distribute the softening agents. One limitation exhibited is that a dryer sheet has a tendency to harbor itself. This harboring effect is when the dryer sheet becomes nested in a cavity of an article, such as a sleeve or a fold. As a result of this harboring, the dryer sheet will become isolated from the other articles. Also, the dryer sheet because of its physical make-up of uniform weight may travel in a very confined pattern causing limited exposure to articles.

### SUMMARY OF THE INVENTION

The present invention provides a dryer sheet enhancer, which greatly improves the effectiveness of using a dryer sheet. The dryer sheet enhancer includes a flexible member having a predetermined size and first predetermined shape, and is made from a predetermined material. The flexible member has at least one incision, having a predetermined length, formed through the flexible member at a predetermined location. There is an aperture, having a second predetermined shape, formed through the flexible member at each terminal end of the incision.

The present invention also provides an apparatus for reducing static electricity in articles being dried in an automated dryer and enhancing softness of such articles. Included in the apparatus is a sheet of material treated with softening agents, a flexible member having a predetermined size and a first predetermined shape, and is made from a predetermined material. Included in the flexible member is at least one incision, having a predetermined length, formed through the flexible member at a predetermined location for securing the sheet of material treated with softening agents. Furthermore there is an aperture, having a second predetermined shape, formed through the flexible member at each terminal end of the incision.

### OBJECTS OF THE INVENTION

It is, therefore, a primary objective of the present invention to provide a dryer sheet enhancer, which greatly improves the effectiveness of using a dryer sheet.

Another object of this invention is to provide a dryer sheet enhancer, which will provide a more uniform distribution of softening agents to articles during an automated dryer cycle.

Another object of this invention is to provide a dryer sheet enhancer, which greatly reduces static electricity that is generated between articles during the automated dryer cycle.

Another object of this invention is to provide a dryer sheet enhancer, which is simple to use.

Another object of this invention is to provide a dryer sheet enhancer that has a low cost to produce.

Another object of this invention is to provide a dryer sheet enhancer that is manufactured in a manner that is suitable for multiple uses.

These and various other objects and advantages of this invention will become more readily apparent to those persons skilled in the art after a full reading of the following detailed description, particularly, when such description is read in conjunction with the attached drawings as described below and the appended claims.

### DESCRIPTION OF THE DRAWING

FIG. 1 is a front view of the dryer sheet enhancer.

FIG. 2 is a side view of the dryer sheet enhancer.

### DETAILED DESCRIPTION OF THE PREFERRED EMBODIMENT

Prior to proceeding to a much more detailed description of the present invention, it should be noted that identical components which have identical functions have been identified with identical reference numerals throughout the several views illustrated in the drawing figures for the sake of clarity and understanding of the invention.

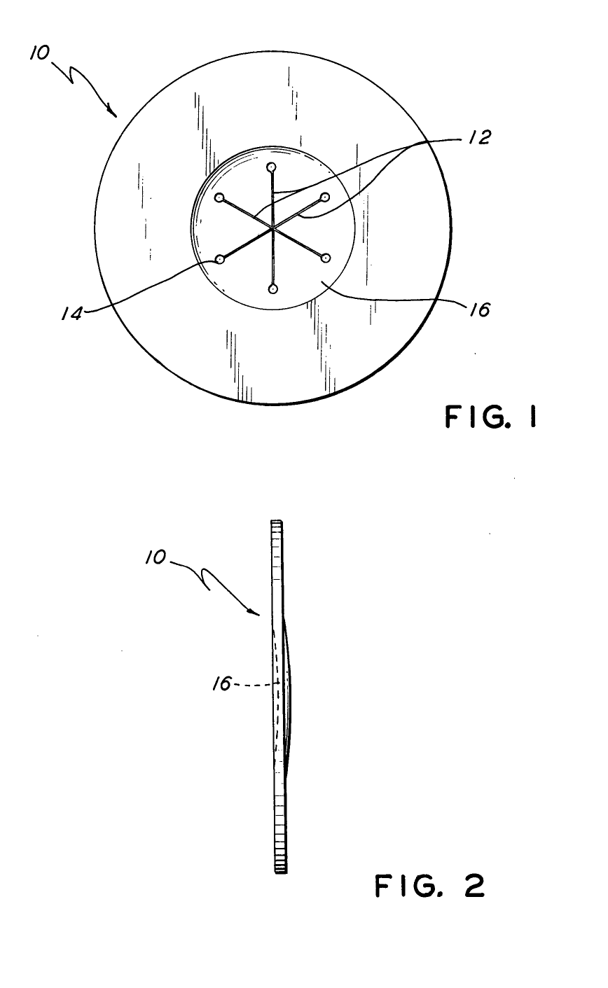

Referring initially to FIG. 1 a dryer sheet enhancer constructed according to the invention is generally indicated by reference numeral 10. The enhancer 10 generally consists of a plastic member suitable for operating temperatures of automated dryer. The enhancer 10 is constructed in a predetermined manner such that it includes a spherical shape with a predetermined diameter and a predetermined thickness. At the center of the device is the intersection of one or more incisions 12. In this particular view three diagonal incisions 12 are shown representing a pie pattern of six equal sections. The incisions 12 are terminated at both ends with an aperture 14 that has a predetermined size to prevent tearing. Also, this described area of the device develops a slight depression, to which, the center 16 exhibits a dish-like appearance.

Referring to FIG. 2, a dryer sheet is attached to enhancer 10 through the following instructions. With the device facing in the proper direction (indicated by arrows) place a corner area of the dryer sheet over the device. With a slight force of a thumb or finger poke the dryer sheet through the center 16 of the device. Once a portion of the dryer sheet is through, gently pull the portion to expose approximately one inch, or two fingers wide. By completing these steps, the dryer sheet is secured to enhancer 10 and ready to be put into service.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A dryer sheet enhancer, for improving the effectiveness of using a dryer sheet, said dryer sheet enhancer comprising:
a) a flexible member having a predetermined size and a first predetermined shape, said flexible member being made from a predetermined material;
b) at least one incision, having a predetermined length, formed through said flexible member at a predetermined location; and
c) an aperture, having a second predetermined shape, formed through said flexible member at each terminal end of said at least one incision.

2. A dryer sheet enhancer, according to claim 1, wherein said flexible member includes a plurality of incisions.

3. A dryer sheet enhancer, according to claim 1, wherein said predetermined material is selected from the group consisting of plastic, cardboard, paper, ferrous metal, non-ferrous metal and any combination thereof.

4. A dryer sheet enhancer, according to claim 1, wherein said second predetermined shape is generally rounded.

5. A dryer sheet enhancer, according to claim 1, wherein said first predetermined shape is generally dish-like.

6. A dryer sheet enhancer, according to claim 2, wherein said plurality of incisions are at least three.

7. A dryer sheet enhancer, according to clam 3, wherein said material is plastic.

8. A dryer sheet enhancer, according to claim 6, wherein each of said plurality of incisions are terminated with an aperture of a predetermined size to prevent said plurality of incisions from tearing.

9. A dryer sheet enhancer, according to claim 7, wherein said plastic is capable of functioning within normal operating conditions of an automated dryer.

10. An apparatus for reducing static electricity in articles being dried in an automated dryer and enhancing softness of such articles, said apparatus comprising:
a) a sheet of material treated with softening agents;
b) a flexible member having a predetermined size and a first predetermined shape, said flexible member being made from a predetermined material;
c) at least one incision, having a predetermined length, formed through said flexible member at a predetermined location for securing said sheet of material treated with softening agents; and
d) an aperture, having a second predetermined shape, formed through said flexible member at each terminal end of said at least one incision.

11. An apparatus for reducing static electricity in articles being dried in an automated dryer and enhancing softness of such articles, according to claim 10, wherein said flexible member includes a plurality of incisions for securing said material treated with softening agents.

12. An apparatus for reducing static electricity in articles being dried in an automated dryer and enhancing softness of such articles, according to claim 10, wherein said predetermined material is selected from the group consisting of plastic, cardboard, paper, ferrous metal, non-ferrous metal and any combination thereof.

13. An apparatus for reducing static electricity in articles being dried in an automated dryer and enhancing softness of such articles, according to claim 10, wherein said second predetermined shape is generally rounded.

14. An apparatus for reducing static electricity in articles being dried in an automated dryer and enhancing softness of such articles, according to claim 10, wherein said first predetermined shape is generally dish-like.

15. An apparatus for reducing static electricity in articles being dried in an automated dryer and enhancing softness of such articles, according to claim 11, wherein said plurality of incisions used for securing said material treated with softening agents are at least three.

16. An apparatus for reducing static electricity in articles being dried in an automated dryer and enhancing softness of such articles, according to clam 12, wherein said material is plastic.

17. An apparatus for reducing static electricity in articles being dried in an automated dryer and enhancing softness of such articles according to claim 15, wherein each of said plurality of incisions, for securing said material treated with softening agents, are terminated with an aperture of a predetermined size to prevent said plurality of incisions from tearing.

18. An apparatus for reducing static electricity in articles being dried in an automated dryer and enhancing softness of such articles, according to claim 16, wherein said plastic is capable of functioning within normal operating conditions of an automated dryer.
